(19) United States
(12) Patent Application Publication
(10) Pub. No.: US 2006/0274646 A1
(43) Pub. Date: Dec. 7, 2006

(54) Method and apparatus for managing network connection

(75) Inventors: Daiya Nakamura, Kawasaki (JP); Atsuhiro Otaka, Kawasaki (JP); Oumar Thielo, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/237,656

(22) Filed: Sep. 29, 2005

(30) Foreign Application Priority Data
Jun. 2, 2005 (JP) 2005-162814

(51) Int. Cl. H04J 1/16

(52) U.S. Cl. 370/216; 370/254; 709/223

(57) ABSTRACT

An apparatus for managing a network connection between different types of networks via a master port includes a failure detecting unit and a master-port switching unit. The failure detecting unit detects a failure in other apparatus based on a frame for determining the master port transmitted from the other apparatus. The master-port switching unit switches, when the failure detecting unit detects a failure in the other apparatus, the master port of the apparatus from a standby state to an operation state.

### BACKGROUND OF THE INVENTION

1. Field of the Invention

The present invention relates to a technology for managing a network connection between different types of networks.

2. Description of the Related Art

A conventional technology has been disclosed in, for example, Japanese Patent Application Laid-Open No. 2002-342253.

In a network-connection management system according to the conventional technology, two arbitrated loops are created and made redundant in order to improve the reliability in an access to the disk apparatus that is connected to a port of the arbitrated loop.

Therefore, even when a failure occurs in a fabric switch of one of the arbitrated loops, the arbitrated loop in which the failure has occurred is isolated and a fabric switch of the other arbitrated loop is used instead, enabling an access to the disk apparatus that is connected to the port.

However, in order to improve the reliability in the access to the disk apparatuses that are connected to ports of the arbitrated loop, the conventional technology requires the creation of a plurality of arbitrated loops, leading to a problem of considerable cost.

Furthermore, in a selection of a master port based on the LIP sequence, since only one master port can exist on a single arbitrated loop, it is not possible to improve the reliability in the access to the disk apparatus connected to the port simply by providing a plurality of fabric switches on the same loop.

When connecting different networks, in addition to reducing the cost for network connection, it is extremely important to improve the reliability in an access to a node (such as a disk apparatus) that is connected to the port of the arbitrated loop.

### SUMMARY OF THE INVENTION

It is an object of the present invention to at least solve the problems in the conventional technology.

An apparatus according to one aspect of the present invention manages a network connection between different types of networks via a master port. The apparatus includes a failure detecting unit that detects a failure in other apparatus based on a frame for determining the master port transmitted from the other apparatus; and a master-port switching unit that switches, when the failure detecting unit detects a failure in the other apparatus, the master port of the apparatus from a standby state to an operation state.

A method according to another aspect of the present invention, which is for controlling an apparatus for managing a network connection between different types of networks via a master port, includes detecting a failure in other apparatus based on a frame for determining the master port transmitted from the other apparatus; and switching, when a failure is detected in the other apparatus at the detecting, the master port of the apparatus from a standby state to an operation state.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic for illustrating the concept of a fabric switch according to an embodiment of the present invention;

FIG. 2 is a schematic of a network-connection management system according to the present embodiment;

FIG. 3 is a schematic of a network-connection management system when a failure occurs in a fabric switch having a high priority;

FIG. 4 is a block diagram of the fabric switch according to the present embodiment;

FIG. 5 is a flowchart of a process procedure executed by the network-connection management system for an LIP sequence;

FIG. 6 is a flowchart of a process procedure of a fabric switch for a master port selection processing (Step S101) shown in FIG. 5;

FIG. 7 is a flowchart of a process procedure of an NL port for the master port selection processing (Step S101) shown in FIG. 5;

FIG. 8 is a flowchart of a process procedure of a fabric switch 200 when a failure occurs in a fabric switch 100; and

FIG. 9 is a flowchart of a process procedure of the fabric switch 200 when the failure in the fabric switch 100 has been recovered.

### DETAILED DESCRIPTION OF THE PREFERRED EMBODIMENTS

Exemplary embodiments of the present invention will be explained in detail below with reference to the accompanying drawings.

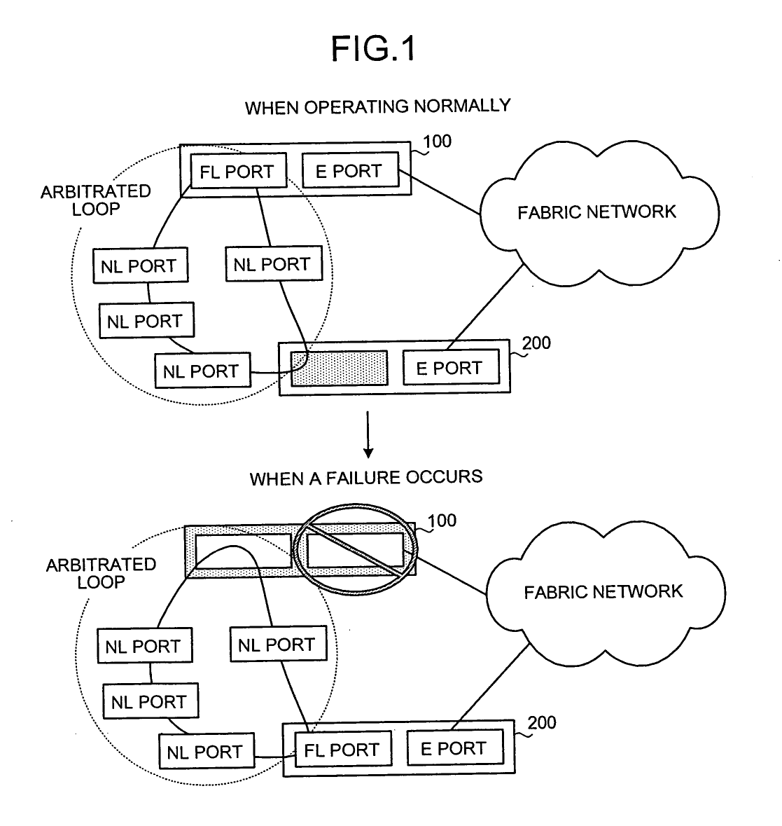

FIG. 1 is a schematic for illustrating the concept of a fabric switch according to an embodiment of the present invention. According to the present embodiment, two fabric switches 100 and 200 are arranged on the arbitrated loop. Each of the fabric switches 100 and 200 has a master port (hereinafter, “FL port”) for connecting a fabric network, to an arbitrated loop that includes a plurality of node loop ports (hereinafter, “NL ports”) for connecting to a node of a disk apparatus and the like.

A priority is allocated to each of the fabric switches 100 and 200. Networks are connected using the fabric switch having the higher priority, while the fabric switch having the lower priority functions as a repeater.

This arrangement will be explained more specifically with an example in which the priority of the fabric switch 100 is higher than that of the fabric switch 200. Normally, the fabric switch 100 connects a fabric network to the arbitrated loop by using the FL port and an E port (a port for connecting to a fabric network).

On the other hand, the fabric switch 200 having a lower priority normally functions as a repeater for the arbitrated loop, monitors frames on the loop, and detects irregularities in the fabric switch 100.

The fabric switch 200 detects irregularities in the fabric switch 100 during a loop initialization process (LIP) sequence. An LIP sequence is a loop initialization process executed when the status on the arbitrated loop changes. This LIP sequence selects a master port on the loop and sets the address of each NL port.

When the fabric switch 200 detects a failure in the fabric switch 100 during the LIP sequence, it connects the fabric network to the arbitrated loop instead of the fabric switch 100.

Thus, even when a failure occurs in the fabric switch 100, the fabric switch 100 and the fabric switch 200 can easily be switched by using a conventional LIP sequence mechanism, thereby improving the reliability of the arbitrated loop.

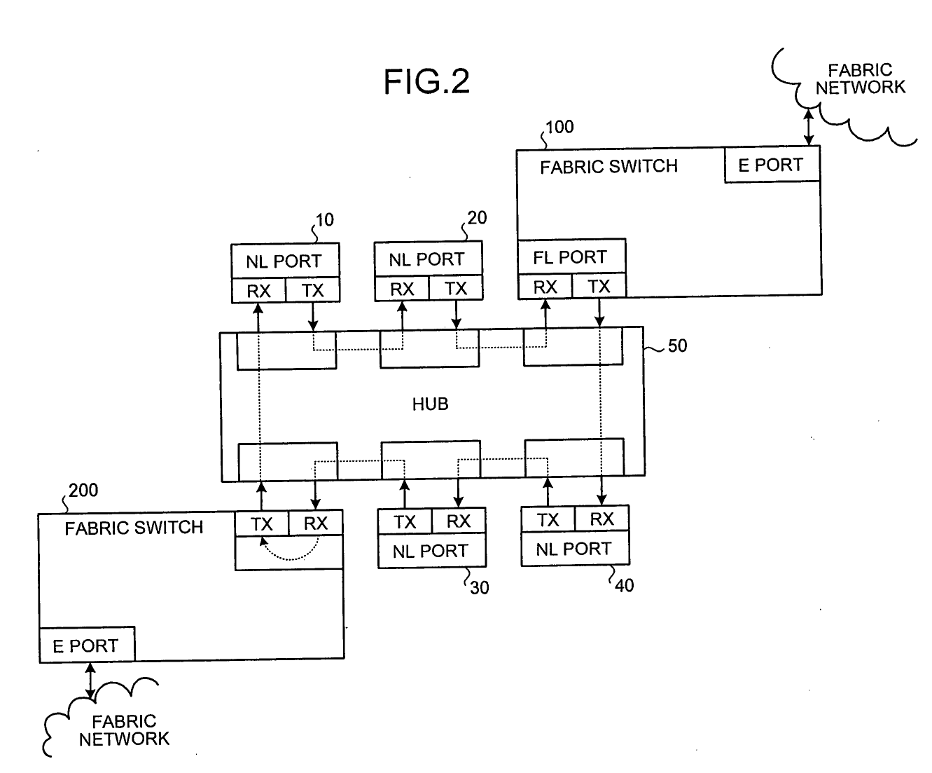

FIG. 2 is a schematic of a network-connection management system according to the present embodiment. The network-connection management system establishes an arbitrated loop by connecting NL ports 10 to 40 and the fabric switches 100 and 200 via a hub 50. The fabric switches 100 and 200 are connected to the fabric network via E ports.

The NL port 10 is an apparatus that connects a node (not shown) such as a disk apparatus or a server apparatus to the arbitrated loop. During an LIP sequence, when the NL port 10 receives a LISM frame (the LISM frame is used for selecting a master port between the nodes during the LIP sequence, the LISM is abbreviation for “loop initialization select master”) via a receiver (RX) from the fabric switch 200, the NL port 10 determines whether the received LISM frame is one created by either of the fabric switches 100 and 200.

When the received LISM frame is created by one of the fabric switches 100 and 200, it is transferred without change to the NL port 20 via a transmitter (TX).

On the other hand, when the received LISM frame is not created by one of the fabric switches 100 and 200, the NL port 10 determines whether the received LISM frame has a higher priority than frames created by the NL port 10. If the priority of the received LISM frame is lower than the LISM frame of the NL port 10, the NL port 10 discards the received LISM frame and transmits a LISM frame created by the own port to the NL port 20.

On the other hand, if the received LISM frame has a higher priority than the LISM frame of the NL port 10, the NL port 10 transfers the received LISM frame without change to the NL port 20. Since the explanation of the NL port 10 applies similarly to the NL ports 20 to 40, redundant explanation thereof will be omitted.

The fabric switches 100 and 200 connect fabric networks to the arbitrated loop. Priorities for the fabric switches 100 and 200 are determined in advance. Normally, the fabric switch with the higher priority connects the fabric network and the arbitrated loop, while the fabric switch with the lower priority functions as a repeater. In this embodiment, an example in which the fabric switch 100 has a higher priority than the fabric switch 200 is explained.

Normally, the fabric switch 100 with the higher priority connects the fabric network to the arbitrated loop, while the fabric switch 200 with the lower priority transfers the frames received from the NL port 30 to the NL port 10.

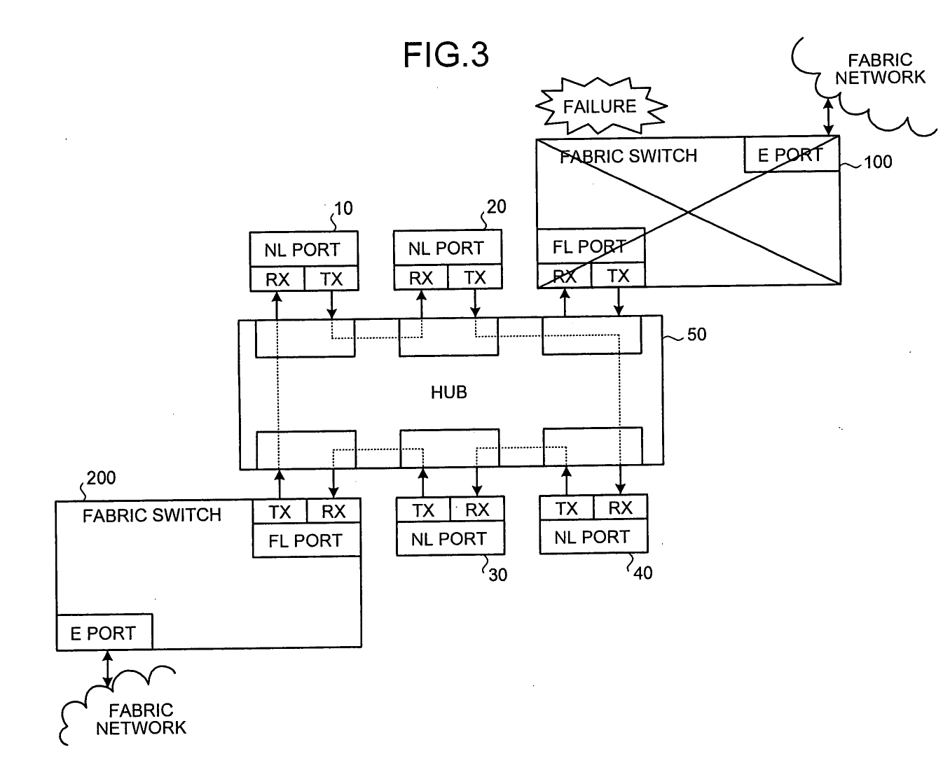

When a failure occurs in the fabric switch 100, the fabric switch 200 connects the fabric network to the arbitrated loop instead of the fabric switch 100. FIG. 3 is a schematic of a network-connection management system when a failure occurs in a fabric switch having a high priority. The fabric switch 100 in which the failure has occurred functions as a repeater. When the fabric switch 100 cannot function as a repeater, a hub 50 makes a hardware detection of a failure (path failure) on the fiber channel (FC) (RX or TX) that leads to the fabric switch 100 and isolates the port that connects to the fabric switch 100 so as to bypass it.

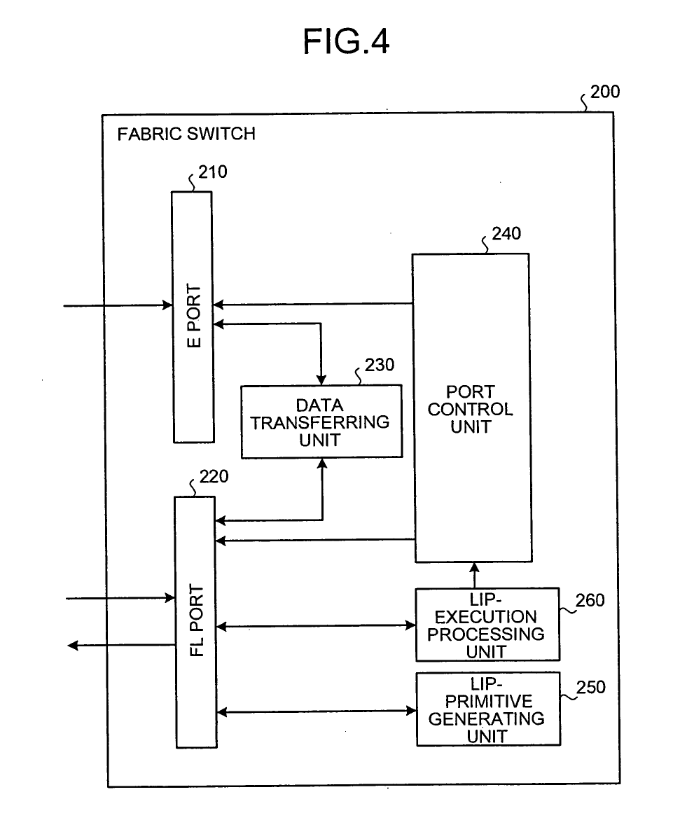

FIG. 4 is a block diagram of the fabric switch according to the present embodiment. The fabric switch 200 includes an E port 210, an FL port 220, a data transferring unit 230, a port control unit 240, an LIP-primitive generating unit 250, and an LIP-execution processing unit 260.

The E port 210 is used for connecting to a fabric network, and transfers data received from the fabric network to the data transferring unit 230. The E port 210 transmits data obtained from the data transferring unit 230 to predetermined addresses on the fabric network.

The FL port 220 is a master port for connecting the arbitrated loop and the fabric network. When no failure occurs in the fabric switch 100 shown in FIG. 2, the FL port 220 of the fabric switch 200 functions as a repeater. In other words, the FL port 220 functions as a repeater when the fabric switch 100 is operating normally, and functions as a master port when a failure occurs in the fabric switch 100.

The data transferring unit 230 is a processor that, when the FL port 220 is functioning as a master port on the arbitrated loop, transfers information obtained from the E port 210 to the FL port 220 and transfers information obtained from the FL port 220 to the E port 210.

The port control unit 240 is a processor that controls the E port 210 and the FL port 220. More specifically, upon obtaining information from the LIP-execution processing unit 260 indicating that a failure has occurred in the fabric switch 100, the port control unit 240 switches the function of the FL port 220 from a repeater to a master port, and connects the fabric network to the arbitrated network.

When information is obtained from the LIP-execution processing unit 260 indicating that the failure in the fabric switch 100 has been resolved, the port control unit 240 switches the function of the FL port 220 from a master port to a repeater.

The LIP-primitive generating unit 250 is a processor that, when the status of the arbitrated loop changes (for example, when a new NL port is connected to the arbitrated loop), generates an LIP primitive to enable it to join in the loop as a master port. The generation of this LIP primitive initiates an LIP sequence on the arbitrated loop.

The LIP-execution processing unit 260 determines whether a failure has occurred in the fabric switch 100 based on a LISM frame received during the execution of the LIP sequence, and reports the result of this determination to the port control unit 240. After reporting occurrence of the failure in the fabric switch 100 to the port control unit 240, when the LIP-execution processing unit 260 detects that the fabric switch 100 has recovered, it reports that the failure of the fabric switch 100 has been resolved, to the port control unit 240.

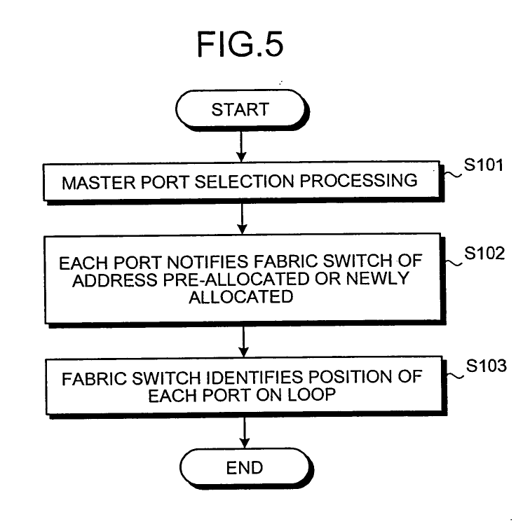

FIG. 5 is a flowchart of a process procedure executed by the network-connection management system for an LIP sequence. When the status on the arbitrated loop changes, LISM frames are transmitted from each of the ports (the NL ports 10 to 40 and the fabric switches 100 and 200) and a master port selection processing is performed. Normally, the FL port of the fabric switch 100 is selected as the master port (step S101).

Each of the ports (the NL ports 10 to 40 and the fabric switch 200) reports an address, which is allocated in advance or is newly allocated, to the fabric switch 100 (step S102), and the fabric switch 100 identifies the position of each port on the loop (step S103).

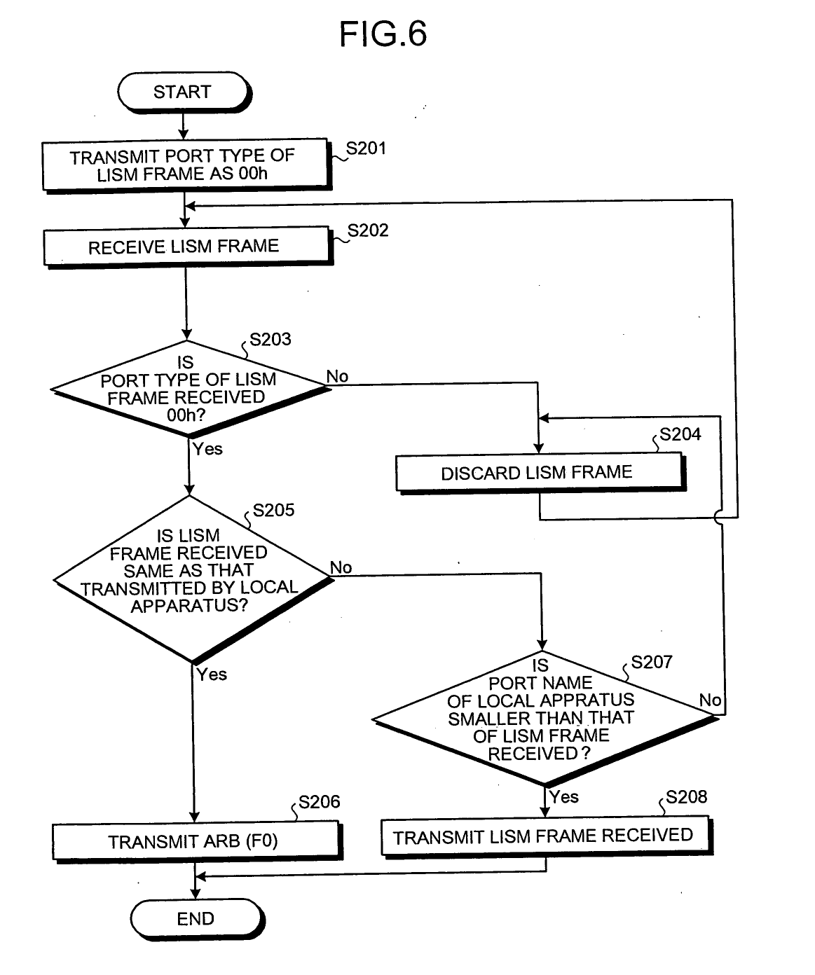

FIG. 6 is a flowchart of a process procedure of a fabric switch for a master port selection processing (Step S101) shown in FIG. 5. During the LIP sequence, the fabric switch 100 sets the port type of the LISM frame to “00h” (setting the port type to 00h makes it possible to determine that the LISM frame has been created by the fabric switch 100 or 200) and transmits the LISM frame to the NL port 40 (step S201).

The fabric switch 100 then receives a LISM frame from the NL port 20 (step S202) and determines whether the port type of the received LISM frame is 00h (step S203).

If the port type of the received LISM frame is not 00h (step S203, No) the fabric switch 100 discards the LISM frame (step S204) and proceeds to step S202. On the other hand, if the port type of the received LISM frame is 00h (step S203, Yes) the fabric switch 100 determines whether the LISM frame is the same as the one transmitted by the own apparatus (the fabric switch 100) (step S205). If it is the same LISM frame (step S205, Yes), the fabric switch 100 transmits an ARB (F0) to the NL port 40 (step S206).

By transmitting this ARB (F0), the fabric switch 100 informs the other ports (NL ports 10 to 40) that a master port has been selected.

On the other hand, if the received LISM frame is not the same as the one transmitted by the fabric switch 100 (step S205, No), the fabric switch 100 determines whether its own port name is smaller than that of the received LISM frame (step S207). If its own port name is smaller than that of the received LISM frame (step S207, Yes), the fabric switch 100 transmits the received LISM frame to the NL port 40 (step S208). If the port name of the received LISM frame is larger than its own port name (step S207, No), the fabric switch 100 proceeds the processing to step S204 to discard the LISM frame.

In addition to a port type, a LISM frame includes a port name. When the port types of LISM frames are the same, their Priorities are determined by using their port names. In the LIP sequence used in this embodiment, the smaller the value of the port name, the higher the priority.

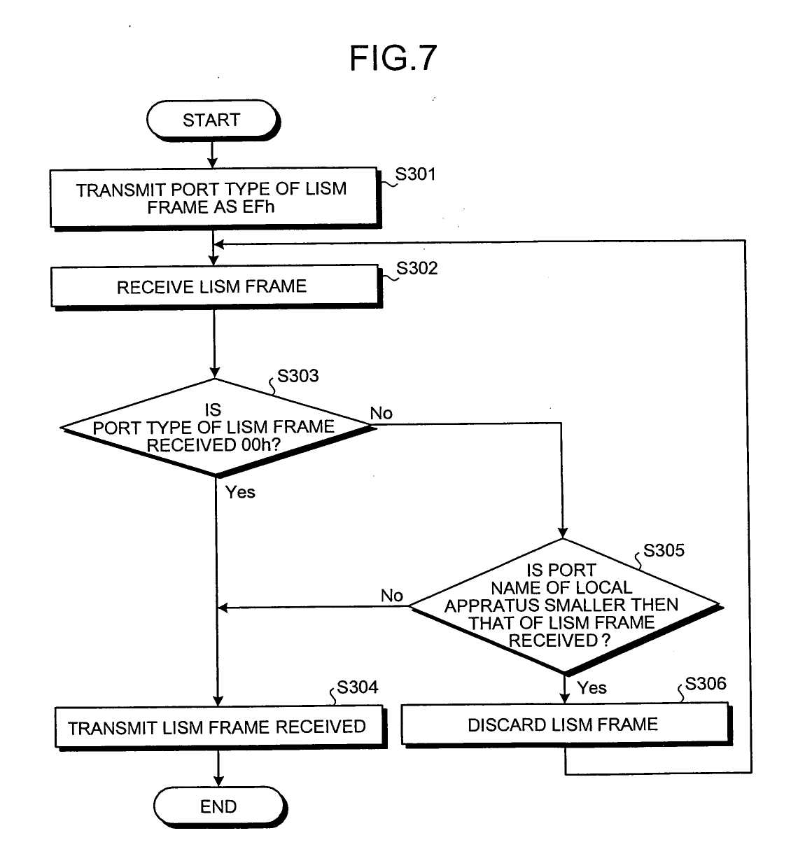

FIG. 7 is a flowchart of a process procedure of an NL port for the master port selection processing (Step S101) shown in FIG. 5. During the LIP sequence, the NL port 10 sets the port type of the LISM frame to “EFh” (setting the port type to EFh makes it possible to determine that the LISM frame has been created by one of the NL ports 10 to 40) and transmits it to the NL port 20 (step S301).

The NL port 10 then receives a LISM frame from the fabric switch 200 (step S302) and determines whether the port type of this LISM frame is 00h (step S303). If the port type of the received LISM frame is 00h (step S303, Yes) the NL port 10 transmits the received LISM frame to the NL port 20 (step S304).

On the other hand, if the port type of the received LISM frame is not 00h (step S303, No), the NL port 10 determines whether its own port name is smaller than that of the received LISM frame (step S305). If its own port name is smaller (step S305, Yes), the NL port 10 discards the received LISM frame (step S306) and proceeds the processing to step S302. On the other hand, if its own port name is not smaller (step S305, No), the NL port 10 proceeds the processing to step S304.

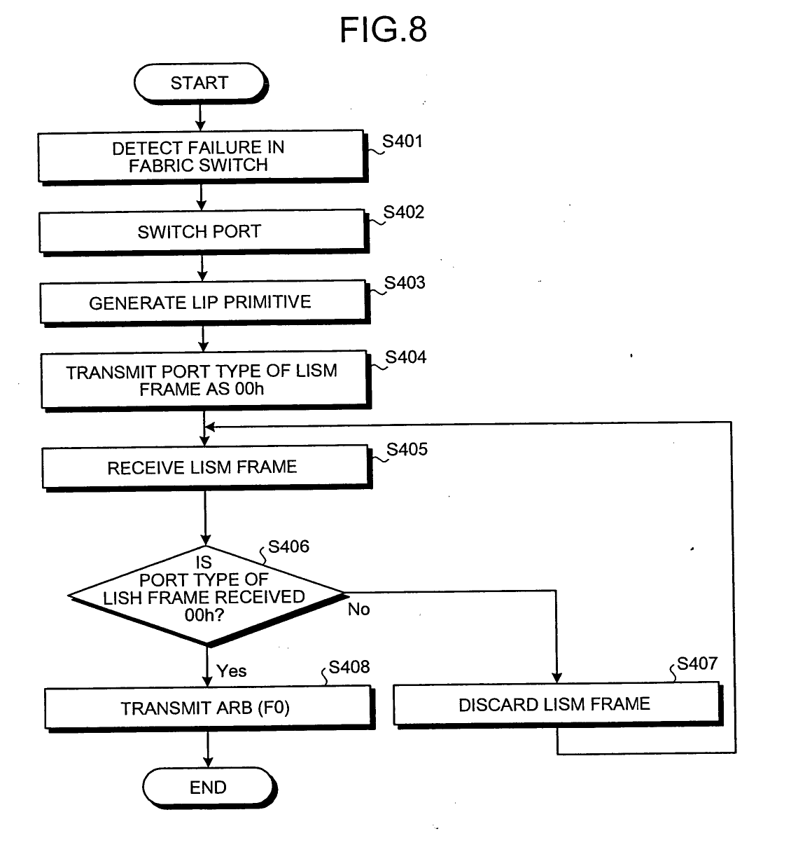

FIG. 8 is a flowchart of a process procedure of a fabric switch 200 when a failure occurs in a fabric switch 100. The LIP-execution processing unit 260 of the fabric switch 200 detects a failure in the fabric switch 100 (step S401). More specifically, at step S401, during the LIP sequence, the LIP-execution processing unit 260 checks the LISM frame, and, when the port type of the LISM frame immediately before the fabric switch 100 transmits the ARB (F0) is not 00h (or, during the LIP sequence, when a LISM frame having a port type of 00h is not received within a predetermined time after the LIP primitive is transmitted), determines that a failure has occurred in the fabric switch 100.

The port control unit 240 switches the function of the FL port from a repeater to a master port (step S402), and the LIP-primitive generating unit 250 generates an LIP primitive (step S403). The port type of the LISM frame is set to 00h and the LISM frame is transmitted to the NL port 10 (step S404).

The LIP-execution processing unit 260 receives the LISM frame (step S405) and determines whether the port type of the LISM frame is 00h (step S406). When the port type is not 00h (step S406, No), the LIP-execution processing unit 260 discards the received LISM frame (step S407) and proceeds the processing to step S405.

On the other hand, when the received port type is 00h (step S406, Yes), the LIP-execution processing unit 260 transmits an ARB (F0) (step S408).

Thus, when the LIP-execution processing unit 260 detects a failure in the fabric switch 100, the port control unit 240 switches the function of the FL port 220 from a repeater to a master port. Therefore, the fabric network can be connected to the arbitrated loop even when a failure occurs in the fabric switch 100, and the reliability of the arbitrated loop can be improved.

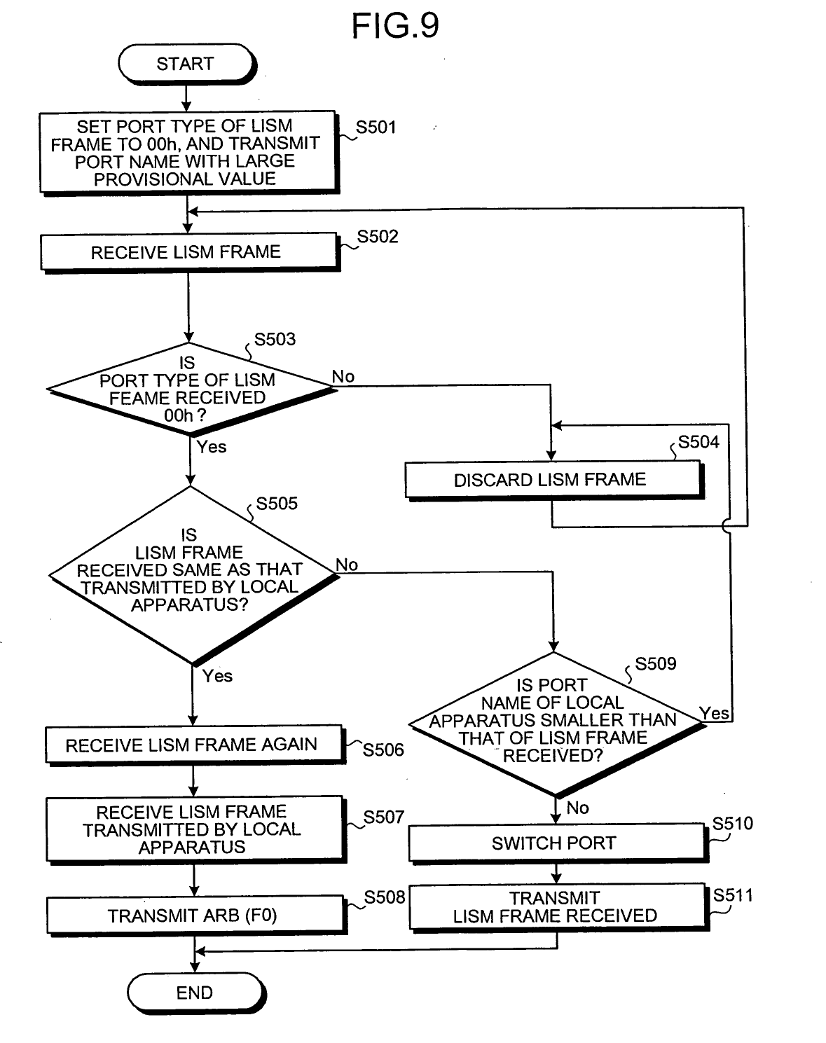

FIG. 9 is a flowchart of a process procedure of the fabric switch 200 when the failure in the fabric switch 100 has been recovered. During the LIP sequence, the LIP-execution processing unit 260 of the fabric switch 200 sets the port type of the LISM frame to 00h and sets the port name to a large provisional value (step S501).

The LIP-execution processing unit 260 then receives a LISM frame (step S502) and determines whether the port type of the LISM frame is 00h (step S503). If the port type is not 00h (step S503, No), the LIP-execution processing unit 260 discards the received LISM frame (step S504) and proceeds the processing to step S502.

On the other hand, when the port type is 00h (step S503, Yes), the fabric switch 200 determines whether the LISM frame is the same as the one transmitted by the own apparatus (step S505), and if so (step S505, Yes), retransmits the LISM frame with a normal port name value (step S506). The fabric switch 200 receives the LISM frame transmitted by the own apparatus (step S507) and transmits an ARB (F0) (step S508).

On the other hand, when the received LISM frame is different from that of the fabric switch 200 (step S505, No), the fabric switch 200 determines whether its own port name is smaller than the port name of the received LISM frame (step S509). If its own port name is smaller (step S509, Yes), the fabric switch 200 proceeds the processing to step S504.

On the other hand, when its own port name is not smaller (step S509, No), the port control unit 240 switches the function of the FL port 220 from a master port to a repeater (step S510), and transmits the LISM frame received by the LIP-execution processing unit 260 to the NL port 10 (step S511).

Thus, when the LIP-execution processing unit 260 detects that the failure in the fabric switch 100 has been resolved, the port control unit 240 switches the function of the FL port from a master port to a repeater, thereby enabling the fabric switch 100 to start operating again efficiently.

At step S505, when the received LISM frame is different from the LISM frame of the own apparatus, i.e., when the received LISM frame has a different port type to the port type generated by the own apparatus, the failure in the fabric switch 100 is determined to have been resolved and the fabric switch 200 switches to a repeater.

At step S501, the fabric switch 200 initially sets the port name to a large provisional value instead of the actual port name in order to ensure that, when the fabric switch 100 where the failure has been resolved receives a LISM frame from the fabric switch 200, the fabric switch 100 surely discards this LISM frame and the fabric switch 200 can reliably receive a LISM frame from the fabric switch 100.

At step S507, since the fabric switch 200 can receive the provisional LISM frame, the fabric switch 200 can reliably determine that the fabric switch 100 is not on the loop. Therefore, the fabric switch 200 retransmits the LISM frame with its actual port name and functions as an FL port.

In the fabric switch 200 according to the present embodiment described above, during the LIP sequence, when the LIP-execution processing unit 260 detects a failure in the fabric switch 100 based on a frame transmitted from the fabric switch 100, the port control unit 240 switches the function of the FL port 220 from a repeater to a master port and connects the fabric network to the arbitrated loop. Therefore, the reliability in access to nodes connected on the arbitrated loop can be improved by using the conventional LIP sequence. Costs can be greatly reduced, since there is no need to establish multiple arbitrated loops as in the conventional technique.

Although the priority of the fabric switch 100 is higher than that of the fabric switch 200 in the present embodiment, the priority of the fabric switch 200 can be higher than that of the fabric switch 100 instead.

If the priority of the fabric switch 200 is higher than that of the fabric switch 100, normally, the fabric switch 200 connects the fabric network and the arbitrated loop while the fabric switch 100 functions as a repeater. When a failure occurs in the fabric switch 200, the fabric switch 100 connects the fabric network and the arbitrated loop instead of the fabric switch 200.

According to the present invention, the reliability in a network connection between different networks can be improved.

Furthermore, other network-connection management apparatus can be recovered easily.

Moreover, the other network-connection management apparatus can be recovered efficiently by using a conventional LIP sequence.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An apparatus for managing a network connection between different types of networks via a master port, the apparatus comprising:
a failure detecting unit that detects a failure in other apparatus based on a frame for determining the master port transmitted from the other apparatus; and
a master-port switching unit that switches, when the failure detecting unit detects a failure in the other apparatus, the master port of the apparatus from a standby state to an operation state.

2. The apparatus according to claim 1, wherein when the frame received includes information indicating that a current master port has a priority higher than that of the master port of the apparatus, the master-port switching unit switches the master port of the apparatus from the operation state to the standby state.

3. The apparatus according to claim 1, further comprising a frame transmitting unit that transmits, at a time of selecting the master port, a frame for determining the master port with a priority of the master port of the apparatus set to low.

4. The apparatus according to claim 1, further comprising a transferring unit that transfers, when a master port of the other apparatus is operating normally, data received from a port to other port.

5. A method of controlling an apparatus for managing a network connection between different types of networks via a master port, the method comprising:
detecting a failure in other apparatus based on a frame for determining the master port transmitted from the other apparatus; and
switching, when a failure is detected in the other apparatus at the detecting, the master port of the apparatus from a standby state to an operation state.

6. The method according to claim 5, wherein when the frame received includes information indicating that a current master port has a priority higher than that of the master port of the apparatus, the switching includes switching the master port of the apparatus from the operation state to the standby state.

7. The method according to claim 5, further comprising transmitting, at a time of selecting the master port, a frame for determining the master port with a priority of the master port of the apparatus set to low.

8. The method according to claim 5, further comprising transferring, when a master port of the other apparatus is operating normally, data received from a port to other port.
